(19) United States
(12) Patent Application Publication
(10) Pub. No.: US 2010/0158593 A1
(43) Pub. Date: Jun. 24, 2010

(54) METHOD AND APPARATUS FOR FLUFFER ENVIRONMENTAL CONTROL IN AN IMAGE PRODUCTION DEVICE

(75) Inventor: Robert Alan CLARK, Williamson, NY (US)

Correspondence Address: Prass LLP, 2661 Riva Road, Building 1000, Suite 1044, Annapolis, MD, 21401, US

(73) Assignee: XEROX CORPORATION, Norwalk, CT (US)

(21) Appl. No.: 12/339,144

(22) Filed: Dec. 19, 2008

(51) Int. Cl. G03G 15/00

(52) U.S. Cl. 399/390

(57) ABSTRACT

A method and apparatus for fluffer environmental control in an image production device is disclosed. The method may include determining a media type to be used for processing a print job, determining a target relative humidity for the determined media type, measuring an ambient temperature and relative humidity, determining whether air blown from a media stack fluffer needs to be heated based on the determined target relative humidity and the measured ambient temperature and relative humidity, wherein if it is determined that the fluffer air needs to be heated, heating the fluffer air to reach target relative humidity, and processing the print job.

### BACKGROUND

Disclosed herein is a method for fluffer environmental control in an image production device, as well as corresponding apparatus and computer-readable medium.

Given the desire of image production device customers to print on a broad range of substrates, the ability to devise a reliable sheet feeder has been an important yet ongoing challenge. More particularly, media such as coated paper has proven to be difficult to feed in high humidity environments due to the properties of the coating used on the paper.

Certain image production devices utilize air heaters incorporated into the feeder media fluffing subsystems to reduce the relative humidity of the air jets emanating from the fluffers so that coated media can be reliably separated. However, when activated, the air heaters increase the fluffer air temperature by a fixed amount regardless of the ambient relative humidity. This process causes excessive heating which results in image quality issues due to excessive drying of uncoated media.

### SUMMARY

A method and apparatus for fluffer environmental control in an image production device is disclosed. The method may include determining a media type to be used for processing a print job, determining a target relative humidity for the determined media type, measuring an ambient temperature and relative humidity, determining whether air blown from a media stack fluffer needs to be heated based on the determined target relative humidity and the measured ambient temperature and relative humidity, wherein if it is determined that the fluffer air needs to be heated, heating the fluffer air to reach target relative humidity, and processing the print job.

### BRIEF DESCRIPTION OF THE DRAWINGS

FIG. 1 is an exemplary diagram of an image production device in accordance with one possible embodiment of the disclosure;

FIG. 2 is an exemplary block diagram of the image production device in accordance with one possible embodiment of the disclosure;

FIG. 3 is an exemplary block diagram of the fluffer environmental control environment in the image production device in accordance with one possible embodiment of the disclosure;

FIG. 4 is a flowchart of an exemplary fluffer environmental control process in accordance with one possible embodiment of the disclosure;

FIG. 5 is an exemplary graph illustrating saturation vapor pressure of water vs. temperature in accordance with one possible embodiment of the disclosure; and

FIG. 6 is a diagram of a media stack being fluffed by a fluffer in accordance with one possible embodiment of the disclosure.

### DETAILED DESCRIPTION

Aspects of the embodiments disclosed herein relate to a method for fluffer environmental control in an image production device, as well as corresponding apparatus and computer-readable medium.

The disclosed embodiments may include a method for fluffer environmental control in an image production device. The method may include determining a media type to be used for processing a print job, determining a target relative humidity for the determined media type, measuring an ambient temperature and relative humidity, determining whether air blown from a media stack fluffer needs to be heated based on the determined target relative humidity and the measured ambient temperature and relative humidity, wherein if it is determined that the fluffer air needs to be heated, heating the fluffer air to reach target relative humidity, and processing the print job.

The disclosed embodiments may further include an image production device that may include a heater that heats fluffer air, one or more sensors that measure ambient temperature, one or more sensors that measure ambient relative humidity, and a fluffer environmental control unit that determines a media type to be used for processing a print job, determines a target relative humidity for the determined media type, determines whether air blown from a media stack fluffer needs to be heated based on the determined target relative humidity and the measured ambient temperature and ambient relative humidity, wherein if the fluffer environmental control unit determines that the fluffer air needs to be heated, the heater heats the fluffer air to reach target relative humidity and the print job is processed.

The disclosed embodiments may further include a computer-readable medium storing instructions for controlling a computing device for fluffer environmental control in an image production device. The instructions may include determining a media type to be used for processing a print job, determining a target relative humidity for the determined media type, measuring an ambient temperature and relative humidity, determining whether air blown from a media stack fluffer needs to be heated based on the determined target relative humidity and the measured ambient temperature and relative humidity, wherein if it is determined that the fluffer air needs to be heated, heating the fluffer air to reach target relative humidity, and processing the print job.

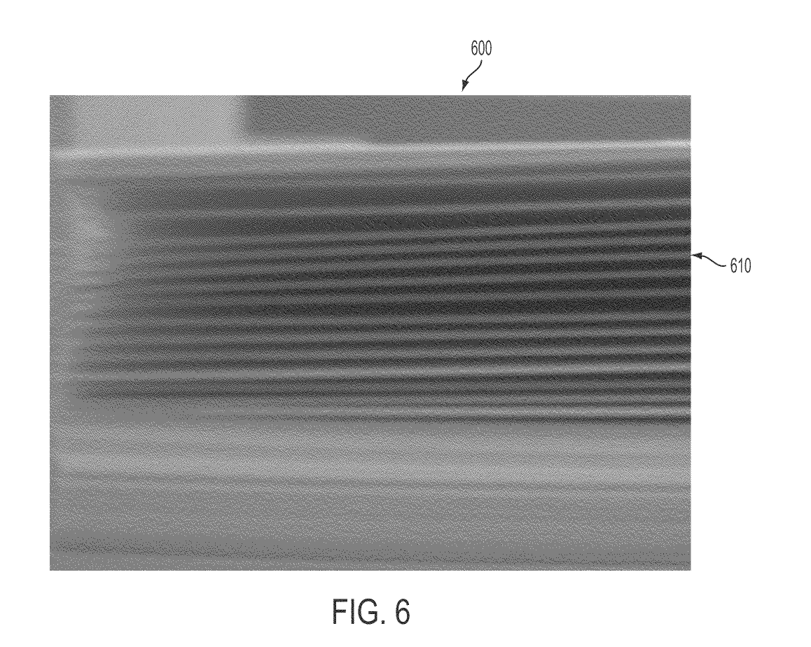

The disclosed embodiments may concern a method and apparatus for a method for fluffer environmental control in an image production device. Fluffing is the process of blowing air onto a media stack to create separation between the media sheets in order to avoid jamming of the image production device. FIG. 6 shows an example 600 of a media stack 610 being fluffed by a fluffer. Conventional image production devices use air heaters in their vacuum corrugated feeders to increase the temperature of the air used in the sheet fluffing system. This reduces the relative humidity of the air, which significantly improves sheet separation.

However, once the heater is activated the temperature is raised a fixed amount regardless of the ambient relative humidity (RH). This temperature increase was established in a “worst case” environment (80° F., 80% RH), where the relative humidity of the fluffer air was reduced to the point where reliable feeding was achieved. For one type of shuttle feeder, the necessary temperature increase was found to be about 35° F. which reduced the RH from an ambient value of 80% to about 20%.

The control algorithm for the heater was then developed, and it was decided that the heater would be active for coated paper regardless of humidity and for uncoated paper if the relative humidity exceeded 26%. If the heater is turned on at 70° F. and 27% RH, the air exiting the fluffer will be at 105° F. and 7% RH.

Not surprisingly, this fluffer air significantly dried out the paper at the fluffers. Due to the corresponding change in resistivity of the sheet, image deletion problems tended to occur at these locations.

According to the disclosed embodiments, image deletion problems can be largely avoided by only applying enough heat to assure reliable sheet separation. This is accomplished by using a variable temperature increase which may be set according to the ambient conditions recorded at the onset of a print job. Instead of a fixed temperature increase being used, a target RH value of the fluffer air may be specified. At the beginning of a print job, the controller may read in the ambient temperature and relative humidity and then uses a pre-programmed relationship to determine the temperature increase needed to drop the RH of the fluffer air down to its target value. This approach may mitigate the deletion issue while also significantly lowering heater power usage.

The shuttle feeder may have a fluffer air heater which is controlled via a thermistor located several inches downstream of the heater element. The current control algorithm may simply maintain a temperature difference between the ambient air and the air passing the thermistor, for example. What is desired is to achieve a temperature such that the target RH is achieved at the thermistor.

Assumptions:

Steady state system

Heat loss after thermistor can be ignored

Air is well-mixed (uniform temperature)

There may be two points of interest. The first point may be the ambient environment, and the second point may be the air at the thermistor location. The relative humidity at any point may be given by the following expression:

$$ϕ = \frac{{p}_{W}}{{p}_{WS}} \times 100$$

where:
p_{w}: Vapor partial pressure (mbar)
p_{ws}: Saturation vapor partial pressure (mbar)

For the purpose of the following analysis, the relative humidity may be treated as a ratio instead of a percentage. Thus,

$$ϕ = \frac{{p}_{W}}{{p}_{WS}} \qquad ( 1 )$$

During the heating process, the actual mass of the water entrained in the air doesn't change. Accordingly, the humidity ratio may be treated as a constant. The humidity ratio may be expressed as:

$$x = 0.62198 \frac{{p}_{w}}{( {p}_{a} - {p}_{w} )} \qquad ( 2 )$$

where:
Pₐ: atmospheric pressure (mbar)

Since x is constant during the heating process,

$${x}_{1} = {x}_{2}$$

$$\frac{{p}_{w ( 1 )}}{( {p}_{a} - {p}_{w ( 1 )} )} = \frac{{p}_{w ( 2 )}}{( {p}_{a} - {p}_{w ( 2 )} )}$$

$${p}_{w ( 1 )} ( {p}_{a} - {p}_{w ( 2 )} ) = {p}_{w ( 2 )} ( {p}_{a} - {p}_{w ( 1 )} )$$

$${p}_{w ( 1 )} {p}_{a} - {p}_{w ( 1 )} {p}_{w ( 2 )} = {p}_{w ( 2 )} {p}_{a} - {p}_{w ( 1 )} {p}_{w ( 2 )}$$

Eliminating common terms and reducing yields:

P_{w(1)}=P₍₂₎ (3)

Solving (1) for p_{w} and then inserting into (3) yields:

$${ϕ}_{( 1 )} {p}_{ws ( 1 )} = {ϕ}_{( 2 )} {p}_{ws ( 2 )} \\ {p}_{ws ( 2 )} = \frac{{ϕ}_{( 1 )}}{{ϕ}_{( 2 )}} {p}_{ws ( 1 )} \qquad ( 4 )$$

Equation (4) provides the saturation vapor pressure at the thermistor given the ambient relative humidity φ₍₁₎, the target relative humidity φ₍₂₎, and the ambient saturation vapor pressure p_{ws(1)}. However, p_{ws} needs to be related to temperature. This is provided via the expression:

$${p}_{ws} = \frac{{e}^{( 77.345 + 0.0057 T - \frac{7325}{T} )}}{{T}^{8.2}} \qquad ( 5 )$$

Substituting (5) into (4) yields

$$\frac{{e}^{( 77.345 + 0.0057 - \frac{7325}{{T}_{2}} )}}{{( {T}_{2} )}^{8.2}} = \frac{{ϕ}_{( 1 )}}{{ϕ}_{( 2 )}} \frac{{e}^{( 77.345 - 0.0057 - \frac{7325}{{T}_{1}} )}}{{( {T}_{1} )}^{8.2}} \qquad ( 6 )$$

Solving equation (6) analytically would create an expression that would be computationally laborious for an embedded microcontroller to execute. A more efficient approach is to incorporate the p_{ws} vs. T relationship as a lookup table for the temperature range of interest.

Thus, a sheet feeder may contain a media fluffing system which would provide some initial separation of the sheets before acquisition. A database of media stored in memory may provide such pertinent info as basis weight, gloss level, and desired relative humidity for feeding. Once a print job is committed, the desired relative humidity ψ₂ may be sent to the feeder controller. The feeder controller may then use the following procedure to determine the desired fluffer air temperature:
1. Obtain values for the ambient temperature T₁ and ambient relative humidity ψ₁.
2. Use the lookup table to calculate p_{ws(1)} using T₁.
3. Calculate p_{ws(2)} using equation (4).
4. Use the lookup table to calculate T₂ using p_{ws(2)}. Lookup table can be effectively transposed by simply swapping row and column indices during linear interpolation.

T₂ is now the target temperature for the fluffer air heater. The feeder controller may activate the heater if needed, and may execute the prefeed cycle a short time after the fluffer air temperature has reached T₂. During the course of the print job, the fluffer air temperature may be maintained at T₂ until the job is complete. The heater may then be deactivated, and the fluffer blower may be left on until the fluffer air temperature drops reasonably close to ambient.

In light of the above, the following benefits of the disclosed embodiments may be:

1) Setting the fluffer air temperature increase according to the desired relative humidity instead of using a table avoids inaccuracies that occur when the actual ambient conditions are different than those upon which the tabulated temperature increase values were based on.

2) As only a small two-dimensional array is needed to calculate the desired fluffer temperature, the amount of processor memory needed should be quite reasonable.

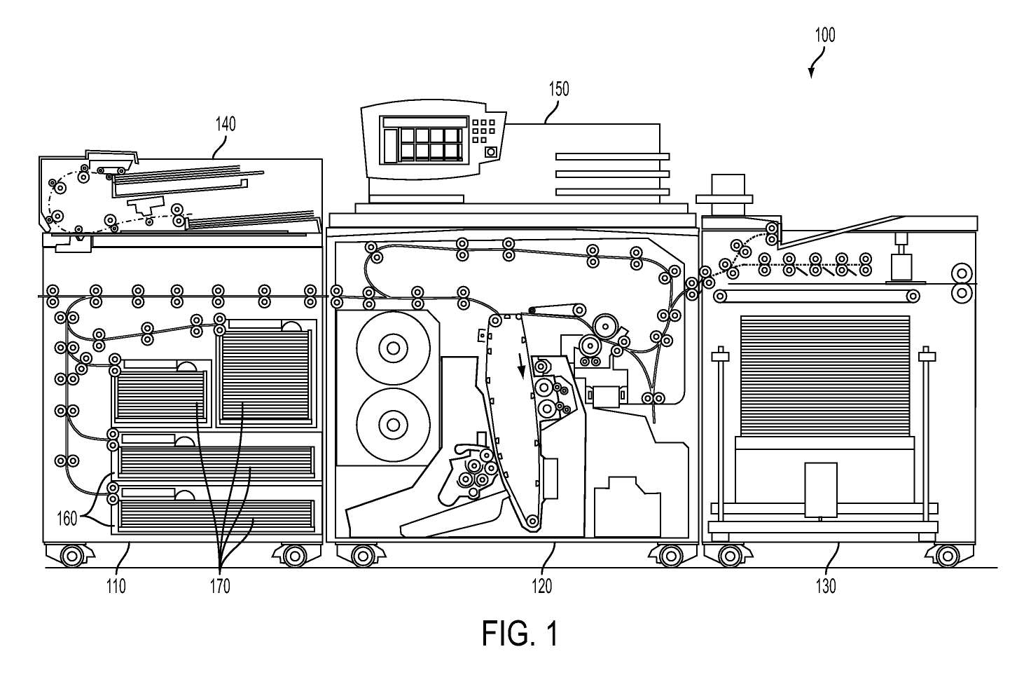

FIG. 1 is an exemplary diagram of an image production device 100 in accordance with one possible embodiment of the disclosure. The image production device 100 may be any device that may be capable of making image production documents (e.g., printed documents, copies, etc.) including a copier, a printer, a facsimile device, and a multi-function device (MFD), for example.

The image production device 100 may include an image production section 120, which includes hardware by which image signals are used to create a desired image, as well as a feeder section 110, which stores and dispenses sheets on which images are to be printed, and an output section 130, which may include hardware for stacking, folding, stapling, binding, etc., prints which are output from the marking engine. If the printer is also operable as a copier, the printer further includes a document feeder 140, which operates to convert signals from light reflected from original hard-copy image into digital signals, which are in turn processed to create copies with the image production section 120. The image production device 100 may also include a local user interface 150 for controlling its operations, although another source of image data and instructions may include any number of computers to which the printer is connected via a network.

With reference to feeder section 110, the module includes any number of trays 160, each of which stores a media stack 170 or print sheets (“media”) of a predetermined type (size, weight, color, coating, transparency, etc.) and includes a feeder to dispense one of the sheets therein as instructed. Certain types of media may require special handling in order to be dispensed properly. For example, heavier or larger media may desirably be drawn from a media stack 170 by use of an air knife, fluffer, vacuum grip or other application (not shown in the Figure) of air pressure toward the top sheet or sheets in a media stack 170.

Certain types of coated media are advantageously drawn from a media stack 170 by the use of an application of heat, such as by a stream of hot air (not shown in the Figure). Sheets of media drawn from a media stack 170 on a selected tray 160 may then be moved to the image production section 120 to receive one or more images thereon. Then, the printed sheet is then moved to output section 130, where it may be collated, stapled, folded, etc., with other media sheets in manners familiar in the art.

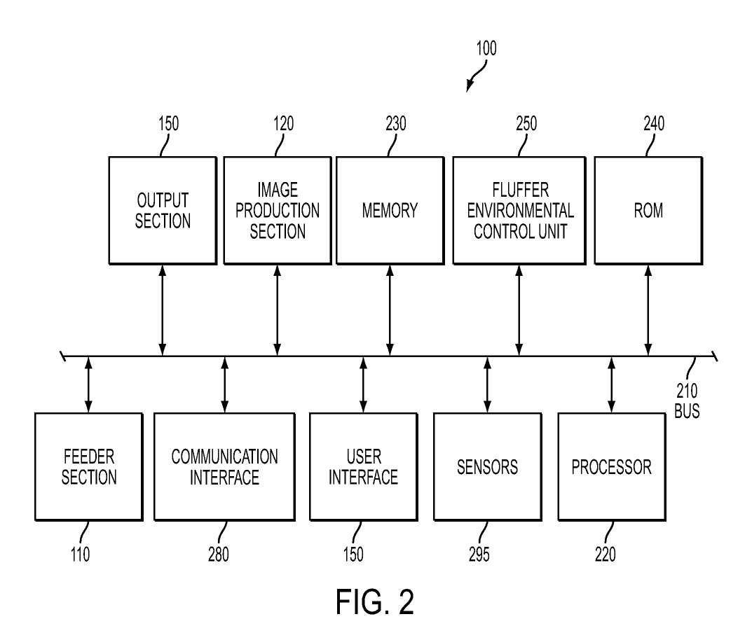

FIG. 2 is an exemplary block diagram of the image production device 100 in accordance with one possible embodiment of the disclosure. The image production device 100 may include a bus 210, a processor 220, a memory 230, a read only memory (ROM 240, a fluffer environmental control unit 250, a feeder section 110, an output section 130, a user interface 150, a communication interface 280, an image production section 120, and sensors 295. Bus 210 may permit communication among the components of the image production device 100.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Communication interface 280 may include any mechanism that facilitates communication via a network. For example, communication interface 280 may include a modem. Alternatively, communication interface 280 may include other mechanisms for assisting in communications with other devices and/or systems.

ROM 240 may include a conventional ROM device or another type of static storage device that stores static information and instructions for processor 220. A storage device may augment the ROM and may include any type of storage media, such as, for example, magnetic or optical recording media and its corresponding drive.

User interface 150 may include one or more conventional mechanisms that permit a user to input information to and interact with the image production unit 100, such as a keyboard, a display, a mouse, a pen, a voice recognition device, touchpad, buttons, etc., for example. Output section 130 may include one or more conventional mechanisms that output image production documents to the user, including output trays, output paths, finishing section, etc., for example. The image production section 120 may include an image printing and/or copying section, a scanner, a fuser, a spreader, etc., for example.

The image production device 100 may perform such functions in response to processor 220 by executing sequences of instructions contained in a computer-readable medium, such as, for example, memory 230. Such instructions may be read into memory 230 from another computer-readable medium, such as a storage device or from a separate device via communication interface 280.

The image production device 100 illustrated in FIGS. 1-2 and the related discussion are intended to provide a brief, general description of a suitable communication and processing environment in which the disclosure may be implemented. Although not required, the disclosure will be described, at least in part, in the general context of computer-executable instructions, such as program modules, being executed by the image production device 100, such as a communication server, communications switch, communications router, or general purpose computer, for example.

Generally, program modules include routine programs, objects, components, data structures, etc. that perform particular tasks or implement particular abstract data types. Moreover, those skilled in the art will appreciate that other embodiments of the disclosure may be practiced in communication network environments with many types of communication equipment and computer system configurations, including personal computers, hand-held devices, multi-processor systems, microprocessor-based or programmable consumer electronics, and the like.

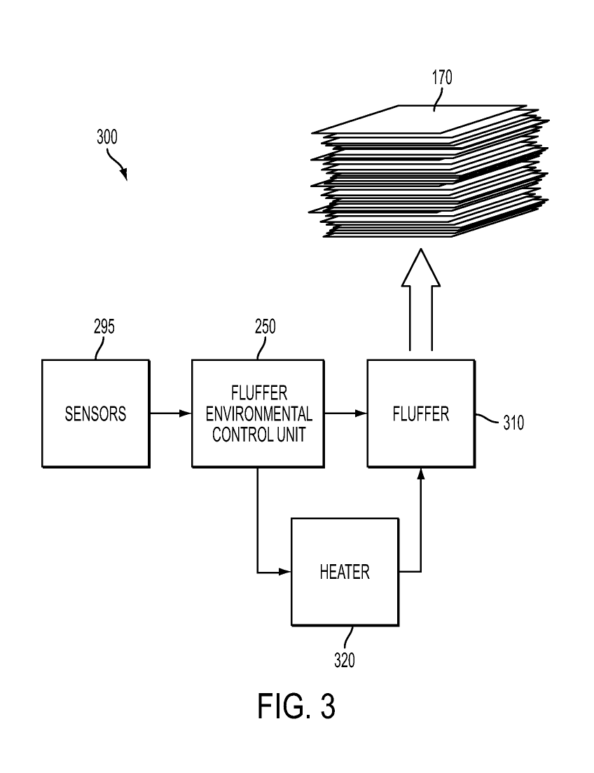

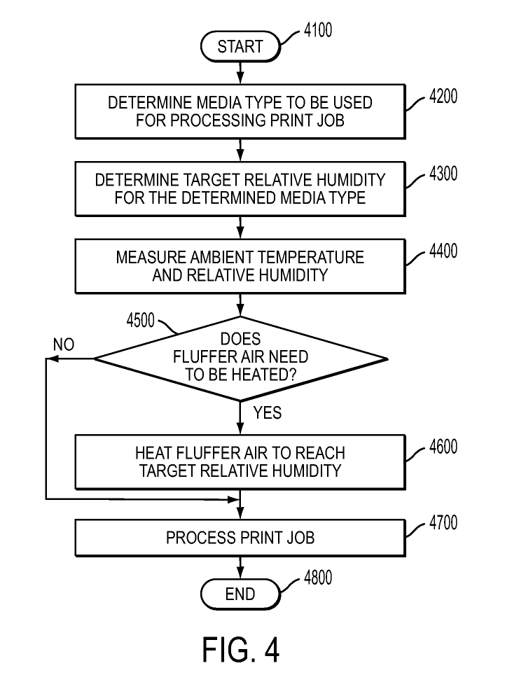

The operation of the fluffer environmental control unit 250 and sensors 295 will be discussed in relation to the block diagram in FIG. 3 and the flowchart in FIG. 4.

FIG. 3 is an exemplary block diagram of the fluffer environmental control environment 300 in the image production device 100 in accordance with one possible embodiment of the disclosure. The fluffer environmental control environment 300 may be found in the feeder section 110 and may include sensors 295, fluffer environmental control unit 250, heater 320, and fluffer 310 directed at a media stack 170. While the term a media stack 170 is used for ease of discussion, the media stack 170 may represent any type of media used to produce documents in the image production device 100, such as any type of paper, plastic, photo paper, cardboard, etc.

Sensors 295 may represent any temperature, relative humidity, or other environmental sensors known to one of skill in the art. The sensors 295 may provide information and measurements to the fluffer environmental control unit 250. The fluffer environmental control unit 250 may then determine whether the heater 320 needs to be activated. If so, the heater 320 may heat the air coming from the fluffer 310 which is blown onto the edges of the media stack 170 to fluff the stack and provide sheet separation. Otherwise, the fluffer 310 may fluff the stack without the fluffer air being heated. Note that the heater 320 and fluffer 310 may be part of the same unit or operate as separate units within the same air system.

The operation of components of the fluffer environmental control unit 250 and the fluffer environmental control process will be discussed in relation to the flowchart in FIG. 4.

FIG. 4 is a flowchart of a fluffer environmental control process in accordance with one possible embodiment of the disclosure. The method begins at 4100, and continues to 4200 where the fluffer environmental control unit 250 may determine a media type to be used for processing a print job.

At step 4300, the fluffer environmental control unit 250 may determine a target relative humidity for the determined media type. The target relative humidity for various media types may be found in a database stored in memory 230, for example. At step 4400, one or more sensors 295 may measure ambient temperature and one or more sensors 295 may measure ambient relative humidity.

At step 4500, the fluffer environmental control unit 250 may determine whether air blown from a media stack fluffer needs to be heated based on the determined target relative humidity and the measured ambient temperature and ambient relative humidity. If the fluffer environmental control unit 250 determines that the fluffer air does not need to be heated, the process goes to step 4700. If the fluffer environmental control unit 250 determines that the fluffer air needs to be heated, at step 4600, the heater 320 heats the fluffer air to reach target relative humidity.

A step 4700, the print job may be processed. The process may then go to step 4800 and end.

The fluffer environmental control unit 250 may determine the target relative humidity by determining a target saturation vapor pressure, for example. In determining the target relative humidity, the fluffer environmental control unit 250 may calculate an ambient saturation vapor pressure based on the measured ambient temperature. The fluffer environmental control unit 250 may then calculate the target saturation vapor pressure from

$${p}_{ws ( 2 )} = \frac{{ϕ}_{( 1 )}}{{ϕ}_{( 2 )}} {p}_{ws ( 1 )} ,$$

where the ambient relative humidity is φ₍₁₎, the target relative humidity is φ₍₂₎, and the ambient saturation vapor pressure is p_{ws(1)}. Then, the fluffer environmental control unit 250 may calculate a target temperature for the fluffer air to reach target relative humidity based on the calculated target saturation vapor pressure. Note that one or more of the calculations may be made using one or more look-up table.

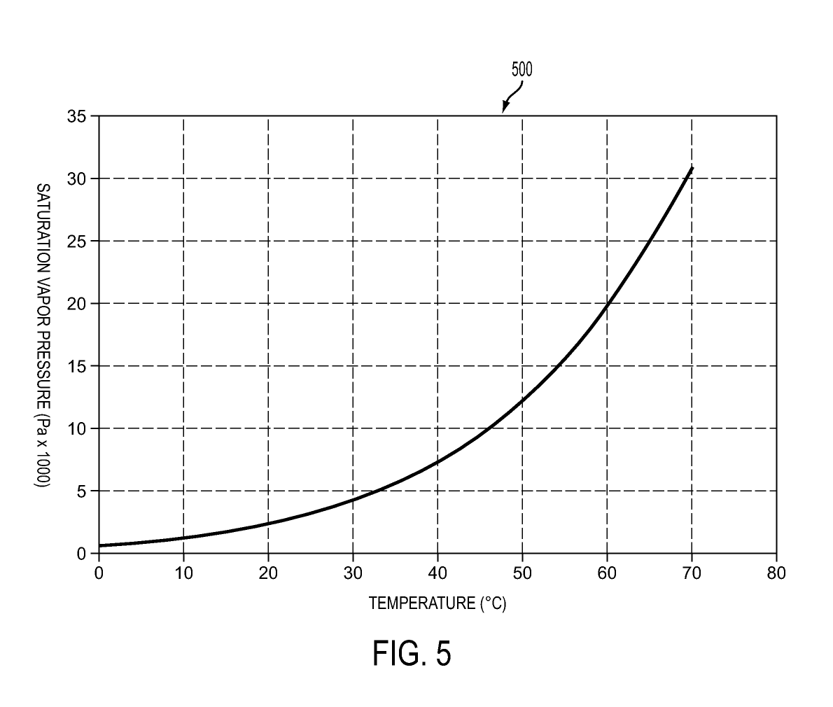

FIG. 5 is an exemplary graph 500 illustrating saturation vapor pressure of water vs. temperature in accordance with one possible embodiment of the disclosure. Since solving the saturated vapor pressure equation analytically would create an expression that would be computationally laborious for the fluffer environmental control unit 250 to execute, a more efficient approach is to incorporate the p_{ws} vs. T relationship as a lookup table for the temperature range of interest may be used. To create a lookup table, 10-15 points representing consecutive [p_{ws}, T] pairs may be picked off the curve. During operation of the heater controller, linear interpolation will then be used to calculate p_{ws(1)} given T₁. To calculate T₂ given p_{ws(2)}, the lookup table matrix may be simply transposed before linear interpolation takes place.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hard wired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein. It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for fluffer environmental control in an image production device, comprising:
determining a media type to be used for processing a print job;
determining a target relative humidity for the determined media type;
measuring an ambient temperature and an ambient relative humidity;
determining whether air blown from a media stack fluffer needs to be heated based on the determined target relative humidity and the measured ambient temperature and relative humidity, wherein if it is determined that the fluffer air needs to be heated,
heating the fluffer air to reach target relative humidity; and
processing the print job.

2. The method of claim 1, further comprising:
calculating an ambient saturation vapor pressure based on the measured ambient temperature;
calculating the target saturation vapor pressure from
$${p}_{ws ( 2 )} = \frac{{ϕ}_{( 1 )}}{{ϕ}_{( 2 )}} {p}_{ws ( 1 )} ,$$
where the ambient relative humidity is φ₍₁₎, the target relative humidity is φ₍₂₎, and the ambient saturation vapor pressure is p_{ws (1)};
calculating a target temperature for the fluffer air to reach target relative humidity based on the calculated target saturation vapor pressure.

3. The method of claim 2, wherein one or more of the calculations are made using one or more look-up table.

4. The method of claim 1, wherein the target relative humidity is determined by determining a target saturation vapor pressure.

5. The method of claim 1, wherein if it is determined that the fluffer air does not need to be heated,
processing the print job.

6. The method of claim 1, wherein the fluffer air is heated using a heater which is separate from the fluffer.

7. The method of claim 1, wherein the image production device is one of a copier, a printer, a facsimile device, and a multi-function device.

8. An image production device, comprising:
a heater that heats fluffer air;
one or more sensors that measure ambient temperature;
one or more sensors that measure ambient relative humidity; and
a fluffer environmental control unit that determines a media type to be used for processing a print job, determines a target relative humidity for the determined media type, determines whether air blown from a media stack fluffer needs to be heated based on the determined target relative humidity and the measured ambient temperature and ambient relative humidity, wherein if the fluffer environmental control unit determines that the fluffer air needs to be heated, the heater heats the fluffer air to reach target relative humidity and the print job is processed.

9. The image production device of claim 8, wherein the fluffer environmental control unit calculates an ambient saturation vapor pressure based on the measured ambient temperature, calculates the target saturation vapor pressure from
$${p}_{ws ( 2 )} = \frac{{ϕ}_{( 1 )}}{{ϕ}_{( 2 )}} {p}_{ws ( 1 )} ,$$
where the ambient relative humidity is φ₍₁₎, the target relative humidity is φ₍₂₎, and the ambient saturation vapor pressure is p_{ws(1)}, and calculates a target temperature for the fluffer air to reach target relative humidity based on the calculated target saturation vapor pressure.

10. The image production device of claim 9, wherein one or more of the calculations are made using one or more look-up table.

11. The image production device of claim 8, wherein the fluffer environmental control unit determines the target relative humidity by determining a target saturation vapor pressure.

12. The image production device of claim 8, wherein if the fluffer environmental control unit determines that the fluffer air does not need to be heated, the print job is processed.

13. The image production device of claim 8, wherein the fluffer air is heated using a heater which is separate from the fluffer.

14. The image production device of claim 8, wherein the image production device is one of a copier, a printer, a facsimile device, and a multi-function device.

15. A computer-readable medium storing instructions for controlling a computing device for fluffer environmental control in an image production device, the instructions comprising:
determining a media type to be used for processing a print job;
determining a target relative humidity for the determined media type;
measuring an ambient temperature and an ambient relative humidity;
determining whether air blown from a media stack fluffer needs to be heated based on the determined target relative humidity and the measured ambient temperature and relative humidity, wherein if it is determined that the fluffer air needs to be heated,
heating the fluffer air to reach target relative humidity; and
processing the print job.

16. The computer-readable medium of claim 15, further comprising:
calculating an ambient saturation vapor pressure based on the measured ambient temperature;
calculating the target saturation vapor pressure from
$${p}_{ws ( 2 )} = \frac{{ϕ}_{( 1 )}}{{ϕ}_{( 2 )}} {p}_{ws ( 1 )} ,$$
where the ambient relative humidity is φ₍₁₎, the target relative humidity is φ₍₂₎, and the ambient saturation vapor pressure is p_{ws(1)};
calculating a target temperature for the fluffer air to reach target relative humidity based on the calculated target saturation vapor pressure.

17. The computer-readable medium of claim 16, wherein one or more of the calculations are made using one or more look-up table.

18. The computer-readable medium of claim 15, wherein the target relative humidity is determined by determining a target saturation vapor pressure.

19. The computer-readable medium of claim 15, wherein if it is determined that the fluffer air does not need to be heated,
processing the print job.

20. The computer-readable medium of claim 15, wherein the fluffer air is heated using a heater which is separate from the fluffer.

21. The computer-readable medium of claim 15, wherein the image production device is one of a copier, a printer, a facsimile device, and a multi-function device.
